(19) United States
(12) Patent Application Publication
(10) Pub. No.: US 2025/0239118 A1
(43) Pub. Date: Jul. 24, 2025

(54) MULTI-SIGNAL BADGE

(71) Applicant: United States Postal Service, Washington, DC (US)

(72) Inventor: David C. Lin, Falls Church, VA (US)

(21) Appl. No.: 19/033,285

(22) Filed: Jan. 21, 2025

Related U.S. Application Data
(60) Provisional application No. 63/622,410, filed on Jan. 18, 2024.

(51) Int. Cl. G07C 9/00; G06K 19/07

(52) U.S. Cl. CPC G07C 9/00309; G06K 19/0702; G06K 19/0723; G07C 2009/00317

(57) ABSTRACT

A system for multi-signal identification, the multi-signal identification badges including two signal devices and a battery, wherein a multi-signal identification badge is associated with a badge identifier, sensors configured to detect the signals emitted by the two signal devices of the multi-signal identification badges, a non-transitory computer storage medium configured to at least store computer executable instructions, and one or more computer hardware processors in communication with the non-transitory computer storage medium, the one or more computer hardware processors configured to execute the computer-executable instructions to at least: create zones within a defined area, determine badge identifiers for the multi-signal identification badges, detect the multi-signal identification badge associated with the badge identifier within a zone, determine a type of zone, and log data regarding the detection of the multi-signal identification badge if the multi-signal identification badge when the type of zone is a locating zone.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Patent Application No. 63/622,410, the entire contents of which are hereby incorporated by reference in their entirety.

### BACKGROUND

The present invention relates to systems, methods, and devices for location detection.

### SUMMARY

In one aspect described herein, a system for multi-signal identification comprises multi-signal identification badges, the multi-signal identification badges including two signal devices and a battery, wherein a multi-signal identification badge is associated with a badge identifier; antennas and/or sensors configured to detect the signals emitted by the two signal devices of the multi-signal identification badges; a non-transitory computer storage medium configured to at least store computer executable instructions; and one or more computer hardware processors in communication with the non-transitory computer storage medium, the one or more computer hardware processors configured to execute the computer-executable instructions to at least: create zones within a defined area; determine badge identifiers for the multi-signal identification badges; detect the multi-signal identification badge associated with the badge identifier within a zone; determine a type of zone; and log data regarding the detection of the multi-signal identification badge if the multi-signal identification badge when the type of zone is a locating zone.

In some embodiments, if the type of zone is an unauthorized zone for the multi-signal identification badge associated with the badge identifier, the system flags the detection as an issue. In some embodiments, if the type of zone is a non-detectability zone for the multi-signal identification badge associated with the badge identifier, the system does not log data. In some embodiments, detecting the multi-signal identification badge associated with the badge identifier within the zone includes starting a timer and attempting to detect the multi-signal identification badge associated with the badge identifier within the zone at intervals. The timer is stopped once the multi-signal identification badge associated with the badge identifier is not found within the zone and the time is recorded and used to determine if the time exceeded a time threshold.

In some embodiments, the system further logs data when the time exceeds the time threshold. In some embodiments, detecting the multi-signal identification badge associated with the badge identifier within a zone further includes determining a need to locate and log badge data; determining the badge identifier to be detected; sending a request for detection to a first set of sensors; receiving detection analysis from the first set of sensors; determining a need for additional detection; sending a request for detection to a second set of sensors; receiving a detection analysis from the second set of sensors; and determining the zone based on the received detection analysis from the first set of sensors and the received detection analysis from the second set of sensors. In some embodiments, the first set of sensors are configured to detect a signal from a first signal device of the two signal devices. In some embodiments, the second set of sensors are configured to detect a signal from a second signal device of the two signal devices.

In one aspect described herein, a multi-signal identification badge includes an identification face and a back face opposite the identification face, wherein the identification face and the back face connect to form a carrying cavity between the identification face and the back face. The multi-signal identification device includes a first signal device, wherein the first signal device is adjacent to the identification face and the back face, a second signal device, wherein the second signal device is adjacent to the identification face and the back face, and a battery, wherein the battery is adjacent to the identification face and the back face. A midline the midline extends through the identification face and the back face and is adjacent to an upper edge of the battery, a lower edge of the first signal device, and a lower edge of the second signal device.

In some embodiments of the multi-signal identification badge, the multi-signal identification badge further includes a beveled edge on the back face at a connection point between the back face and the identification face.

In another aspect described herein, detecting multi-signal identification badge can include creating zones within a defined area and determining badge identifiers for multi-signal identification badges. Within the zones, the multi-signal identification badge associated with a badge identifier are detected and the zone type is determined. Data regarding the detection of the multi-signal identification badge is logged if the type of zone is a detectability zone.

In some embodiments, detecting the multi-signal identification badge can further include receiving a user action from the multi-signal identification badge and setting a flag where the multi-signal identification badge was detected during the user action. System users can then be notified regarding the flag using a notification sent to users associated with the zone where the flag was set. When a system user is detected, via a multi-signal detection badge, within the zone where the flag was set, the flag can be cleared. In some embodiments, detecting the multi-signal identification badge associated with the badge identifier within a zone includes determining a need to locate and log badge data and determining the badge identifier to be detected. A request is sent for detection to a first set of sensors and an analysis is received from the first set of sensors which results in a determination that additional detection is needed. For the additional detection, a request for detection is sent to a second set of sensors and a detection analysis is received from the second set of sensors. The zone is then determined based on the received detection analysis from the first set of sensors and the received detection analysis from the second set of sensors.

In some embodiments, the first set of sensors detects RFID signals. In some embodiments, the first set of sensors detects GPS signals. In some embodiments the second set of sensors detects RFID signals. In some embodiments, the second set of sensors detects NFC signals.

In one aspect described herein, a multi-signal identification badge holder includes a back support sized to extend along an identification face of a multi-signal identification badge to below a cutting line of the multi-signal identification badge and a guiding support perpendicularly connected to the back support that is sized to securely fit adjacent to a multi-signal identification badge. The multi-signal identification badge holder includes a securing face opposite of the back support and perpendicular to the guiding support and a badge carrying cavity that is enclosed on four sides by the back support, securing face, and the guiding support and can hold the multi-signal identification badge. In some embodiments, the securing face further includes a matching bevel to meet a bevel of a back face of the multi-signal identification badge. In some embodiments, the securing face further including connection cavities that can be used to hold the multi-signal identification badge holder in place. In some embodiments, the guiding support further comprises flaps that extend towards the multi-signal identification badge. In some embodiments, multiple multi-signal identification badge holders can be connected along an edge of the securing face.

In another aspect described herein, a system for multi-signal identification comprises a multi-signal identification badges associated with a badge identifier, the multi-signal identification badges comprising: a first signal device; a second signal device; and a battery, in electrical connection with the first signal device and the second signal device; one or more sensors configured to detect signals emitted by the first and second signal devices; one or more processors configured to: determine badge identifiers for the multi-signal identification badges; detect the multi-signal identification badge associated with the badge identifier within one of a plurality of zones of a facility; determine a type of the one of the plurality of zones; and log data regarding detection of the multi-signal identification badge if the multi-signal identification badge when the type of zone is a locating zone.

In some embodiments, the one or more processors are further configured to flag the detection of the multi-signal identification badge if the type of zone is an unauthorized zone for the multi-signal identification badge.

In some embodiments, the one or more processors are further configured to not log data if the type of zone is a non-detectability zone for the multi-signal identification badge associated with the badge identifier.

In some embodiments, in response to detecting the multi-signal badge within one of the plurality of zones, the one or more processors are further configured to: start a timer; detect the multi-signal identification badge associated with the badge identifier within the zone at intervals; stop the timer once the multi-signal identification badge associated with the badge identifier is not within the one of the plurality of zones; and determine that a time elapsed from the start of the time to the stop of the timer exceeds a time threshold.

In some embodiments, the first signal device operates according to a first communication protocol, and wherein the second signal device operates according to a second communication protocol different from the first protocol.

In some embodiments, a first set of the plurality of sensors operate according to the first communication protocol and wherein a second set of the plurality of sensors operate according to the second communication protocol.

In some embodiments, the one or processors are further configured to: send a first request for detection of the multi-signal identification badge to the first set of sensors; receive first detection analysis from the first set of sensors; determine, based on the analysis, a need for additional detection; send a second request for detection to the second set of sensors; receive a second detection analysis from the second set of sensors; and determine the zone based on the first detection analysis from the first set of sensors and the second detection analysis from the second set of sensors.

In some embodiments, the one or processors are further configured to: send a first request for detection of the multi-signal identification badge to the first set of sensors; receive first detection analysis from the first set of sensors; determine, based on the analysis, a need for additional detection; send a second request for detection to the second set of sensors; receive a second detection analysis from the second set of sensors; and determine the zone based on the first detection analysis from the first set of sensors and the second detection analysis from the second set of sensors.

In another aspect described herein, a multi-signal identification badge, the multi-signal identification badge comprises an identification face; a back face opposite the identification face, wherein the identification face and the back face connect to form a cavity between the identification face and the back face; a first signal device, disposed in the cavity; a second signal device, disposed in the cavity; a battery disposed within the cavity; a first electrical connection between the battery and the first signal device; and a second electrical connection between the battery and the second signal device; wherein the first and second signal device are disposed within the cavity above a midline extending through the identification face and the back face, wherein the battery is disposed within the cavity at a location below the midline, and wherein the first electrical connection and the second electrical connection cross the midline.

In some embodiments, the first signal device operates according to a first communication protocol, and wherein the second signal device operates according to a second communication protocol different from the first protocol.

In some embodiments, the multi-signal identification badge further comprises a badge holder, the badge holder comprising: a back support, the back support sized to extend along an identification face of a multi-signal identification badge to below a cutting line of the multi-signal identification badge; a guiding support perpendicularly connected to the back support, wherein the guiding support is sized to securely fit adjacent to the multi-signal identification badge; a securing face, wherein the securing face is opposite of the back support and perpendicular to the guiding support; and a badge cavity, wherein the badge cavity is enclosed on four sides by the back support, securing face, and the guiding support and can hold the multi-signal identification badge.

In some embodiments, the securing face further comprises a matching bevel to meet a bevel of a back face of the multi-signal identification badge.

In some embodiments, the securing face further comprises a plurality of connection cavities, wherein the plurality of connection cavities are configured to hold the multi-signal identification badge holder in place.

In some embodiments, the guiding support further comprise flaps that extend towards the multi-signal identification badge.

In some embodiments, multiple multi-signal identification badge holders can be connected together along an edge of the securing face.

In some embodiments, the back support is sized to be received into a badge cutting machine and position the badge within the multi-signal identification badge holder to cut the multi-signal identification badge the midline.

In another aspect, a method for detecting multi-signal identification, the method comprises creating zones within a defined area; determining badge identifiers for multi-signal identification badges; detecting a multi-signal identification badge associated with a badge identifier within a zone; determining a type of zone; and logging data regarding detection of the multi-signal identification badge if the multi-signal identification badge where the type of zone is a detectability zone.

In some embodiments, the method further comprises receiving user action from the multi-signal identification badge; setting a flag where the multi-signal identification badge was detected; notifying system users of the flag, wherein a notification is sent to system users associated with the zone in which the flag was set; and clearing the flag when a multi-signal identification device associated with the badge identifier that indicates a system user associated with the zone in which the flag was set has entered the zone.

In some embodiments, the method further comprises determining a need to locate and log badge data; determining the badge identifier to be detected; sending a first request for detection to a first set of sensors; receiving a first detection analysis from the first set of sensors; determining a need for additional detection; sending a second request for detection to a second set of sensors; receiving a second detection analysis from the second set of sensors; and determining the zone based on the first detection analysis from the first set of sensors and the second detection analysis from the second set of sensors.

In some embodiments, the first set of sensors detects RFID signals and the second set of sensors detects NFC signals.

### BRIEF DESCRIPTION OF THE DRAWINGS

FIG. 1A depicts a perspective of an identification face of a multi-signal identification badge.

FIG. 1B depicts a perspective of a back face of the multi-signal identification badge of FIG. 1A.

FIG. 1C depicts a side view of the multi-signal identification badge of FIG. 1A-1B.

FIG. 2 depicts a cross-section of a multi-signal identification badge where a back face of the multi-signal identification badge includes a beveled edge.

FIG. 3 depicts a cross section of the beveled edge of FIG. 2 of the multi-signal identification badge where the back face includes a beveled edge.

FIG. 4 depicts an internal view of a multi-signal identification badge.

FIG. 5 is an illustrative flow diagram of a multi-signal identification system process.

FIG. 6 is an illustrative flow diagram of a multi-signal identification badge detection process of a multi-signal identification system.

FIG. 7 is an illustrative flow diagram of a process for detecting user movement implemented by a multi-signal identification system.

FIG. 8 depicts an internal view of a multi-signal identification badge having a midline.

FIG. 9A depicts an illustrative view of an identification face of a multi-signal identification badge that has been cut at the midline.

FIG. 9B depicts an illustrative view of a back face of a multi-signal identification badge which has been cut at the midline.

FIG. 9C depicts a cross sectional view of a multi-signal identification badge that has been cut at the midline.

FIG. 10 depicts an illustrative multi-signal identification badge holder that can hold more than one multi-signal identification badge.

FIG. 11 depicts an illustrative multi-signal identification badge holder mechanism.

FIG. 12 depicts an illustrative multi-signal identification badge holder holding a multi-signal identification badge being used during the cutting process.

FIG. 13 depicts a multi-signal identification badge holder holding a multi-signal identification badge after it has been cut.

### DETAILED DESCRIPTION

Employees and others working or needing access to secure locations or entities with access control policies have traditionally been required to carry multiple different badges or devices to access facilities, for identification, to access or operate equipment, for timekeeping, and the like. A badge or device can advantageously be configured to be multifunctional, for example, to allow access certain areas or through secure doors according to their individual access, for timekeeping, and/or for operating vehicles. A multifunctional badge can eliminate the need for multiple badges, and the badges can include components which remove or reduce the need for a resource to touch or interact with a badge during the course of duties. In some embodiments, the badge can include a summon or announcement feature which can be activated by a resource to summon a resource or to indicate a condition within a distribution environment.

Badges and devices used by or on resources, such as equipment, vehicles, employees, contractors, and others are used for various purposes in a workplace. For example, in a distribution network facility, such as a processing plant, a warehouse, a logistics facility, a shipping dock, a shipping yard, transportation depot, etc., a badge is used to identify a vehicle equipment, or employee, to provide access to various areas, provide access to equipment, for logging in, for timekeeping, and the like. Historically, the various functionalities required from the badges and devices have required employees to carry multiple batches around making work more cumbersome.

The various systems in facilities or workplaces may use different communication hardware or protocol. For example, the access or security system may use an NFC style communication hardware and protocol, and a location identification portion may use a longer-range wireless network, such as a mesh network, a GPS system, or the like. Incorporating various types of hardware with different wireless communication protocols and requirements into a single badge can be difficult, particularly where the possibility for interference exists between RF, Bluetooth, or other wireless communication protocols. In some embodiments, a time management system may use a first identifier and employ a first detecting system, and a door access system or equipment log in system may use a second identifier and a second detecting system. This can be true in facilities with logistics operations where the different equipment and systems have been provided by different entities, or where different systems require different access credentials, levels of assurance, and the like.

Further, access or identification (ID) badges can have built-in power supplies in order to power the various electronic components of the badge, such a notification system, an active RIFD tag, a broadcasting circuit, an audible or visible signal, etc. Thus, disposing of these badges when a badge is old, worn out, defective, when a user leaves an organization or changes information or access requirements, or for other reasons can be difficult due to battery disposal requirements.

The present application is drawn to methods, systems, and devices that reduce the number of badges and devices for employees to carry in an elevated security workplace. A system can include a system server, system controller, sensors, equipment, and one or more multi-signal identification badges wherein the system includes a mesh network for multi-signal identification badge locating and recording. The system server can be one or more processors. The arrangement of components within a multi-signal identification badge allows for a unified badge to access or use multiple different systems, addresses issues of potential interference and battery disposal, and communicate between a system controller and the multi-signal identification badge, under the control of one or more processors. In some embodiments, the device can include one or more onboard signal devices, circuits, or the like situated in a way that allows for multiple signal output without signal interference between the one or more signal devices. The signal devices can be used, for example, to identify multi-signal identification badge locations, provide access to and admission through locked doors and operating facility equipment, and for administrative and timekeeping functions.

The device can be a multi-signal identification badge that includes a front face which provides a space for identification information to be applied and/or displayed. The multi-signal identification badge can further have a back face having interaction features, such as a button, an LED, a notifier, and the like. The button and LED can allow a user to interact with the badge and with computer systems with which the device or badge is in communication. For example, a facility or distribution system or network may receive input from the user via the press of the button on the multi-signal identification badge and/or the system can provide information to the user using the LED or other notification features.

The multi-signal identification badge can be formed from two pieces which include a snap fit or other mechanism that connects the front face and the back face of the multi-signal identification badge together. The front face and the back face can each include a carrying cavity such that, when the front face and the back face of the multi-signal identification badge are connected, the carrying cavity extends through both faces. The carrying cavity can allow attachment of a carrying mechanism to the multi-signal identification badge. In some embodiments, edges of the back face can be beveled to minimize damage from dropping and strengthening the multi-signal identification badge against impact.

When the front face and the back face are connected, the badge can further include a badge cavity that is encapsulated and enclosed on four sides by the front face and the back face. The badge cavity of the multi-signal identification badge can house the one or more signal devices within the badge cavity to prevent interference between the signals of the first signal device and additional signal devices. The signal devices can be separated such that the first signal device and each additional signal device can be fitted against both badge faces. Signal devices can further be configured within the badge cavity to prevent contact physical between signal devices. In some embodiments, the badge can further include a battery that can last for five years or more to prevent badge updates and system reconfiguration on a more frequent basis. The multi-signal identification badges can, in some embodiments, include a weld bead situated internally between the battery and the one or more signal devices. The weld bead can be in a location such that cutting the multi-signal identification badge along the weld bead adds increased safety for the destruction of the multi-signal identification badge without damaging the battery.

The one or more signal devices on the multi-signal identification badge can enable a system to identify multi-signal identification badge locations within a facility. For example, in some embodiments, the facility or workspace can be categorized as zones. Zones can be determined based on actions traditionally performed certain areas in the workspace. For example, a zone may define an aisle on the work floor, an area around item processing equipment, e.g., mail processing equipment (MPE), vehicles, or other equipment, and or a lunchroom or other non-work area. Some zones can be non-detecting zones such as restrooms, break and recovery rooms, cafeterias, parking lots, etc. where badge locations are not determined and/or stored. Such zones can be blind spots within a larger zone or may be a blind spot within a workspace or facility. Data that is collected from the multi-signal identification badges regarding how long badges are in the non-detecting zone may not be logged or may be excluded from some analyses or evaluations.

In some embodiments, the system can log movement of multi-signal identification badges based on timing. For example, if a resource is intended or assigned to be working in an expected zone and the system detects that the multi-signal identification badge for the resource has left the expected zone and has moved to another zone or a non-detectability zone, the system can start a timer to determine how long the badge has been out of an expected zone. In some embodiments, if the badge returns to the expected zone after a limited amount of time as set by a threshold time, the movement is not logged, and the system maintains that the badge had been in the expected area without disruption. Such timer functions can prevent mis-logging movements that were detected by the multi-signal identification badge that do not reflect the resources movements.

In some embodiments, the interactive feature, such as a button, on the multi-signal identification badge may be used by the user to create a flag at a location. In some embodiments, the interaction with the button can cause the system to detect a precise location of the multi-signal identification badge at the time the interaction with the interactive feature occurred. In some embodiments, the interaction with the button can cause the system to flag a zone in which the multi-signal identification badge is located during the interaction with the interactive feature. For example, upon an employee pressing the button on the back face of the multi-signal identification badge, the system can receive a request to flag an area and provide information to additional personnel that could use the information and/or can log that location to the system or network.

The system can further be configured to determine if another multi-signal identification badge associated with a second user is expected to be detected near the flag such that the multi-signal identification badge location of the second user can be interpreted as the second user responding to a notification from the system. The system using a system controller can then remove the flag notification once the multi-signal identification badge associated with the second user has been determined to have entered the location where the flag was set. In some embodiments, the system using a system controller can log the number of flags that have been raised in zones to determine which zones have the most incidents.

In some embodiments, the button can be pressed within the zone of processing equipment to indicate that an equipment malfunction or issue has occurred. When the system detects interaction with an interactive feature, such as a button press, within the zone of item processing equipment, the system can automatically check the status of the equipment within the zone and provide an analysis and/or initiate corrective action, reroute vehicles, summon an automated guidance vehicle (AGV) to perform an action at the processing equipment, and the like.

In some embodiments, after a multi-signal identification multi-signal identification badge has exceeded its usefulness, the owner or user of the multi-signal identification badge has left employment or been reassigned, or for other reasons, the badge may need to be destroyed to protect data, personnel information, access codes, or other information. In such situations, the badge can be inserted into a cutting holder. The cutting holder allows for a badge to be held in place for a cutting mechanism to precisely cut the badge at the weld bead. The cutting holder can hold a single badge or can be a chain of cutting holders to allow for the destruction of more than one badge at any given time. This will be described in greater detail below.

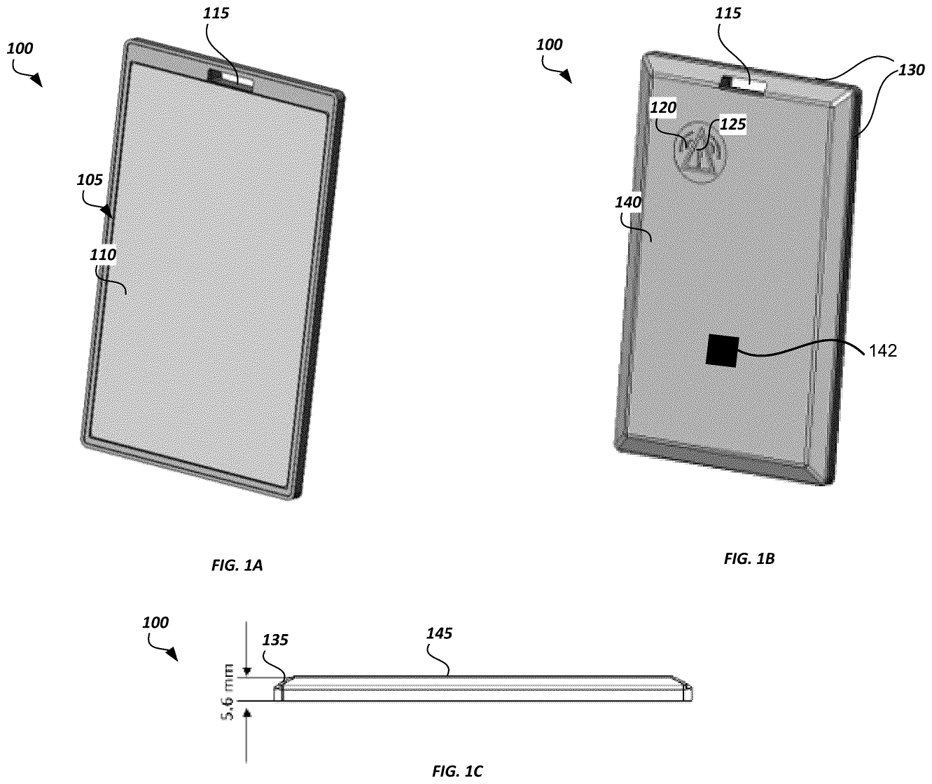

FIGS. 1A-1C depict a multi-signal identification badge 100. FIG. 1A depicts a perspective view of an identification face 105 of a multi-signal identification badge 100 that has a designated space 110 thereon for user information to be added or applied. The user information can be a photograph of a user and related information. The user information can include a computer readable code, access or authorization level indicators, and the like. In some embodiments, the designated space 110 may comprise an e-ink electronic badge area for displaying user information. In some embodiments, the designated space 110 can include a badge identifier associated with the communication circuits or components of the internals of the badge in order to register the badge with the systems and networks of the facility or workspace.

The multi-signal identification badge 100 includes a carrying cavity 115 to which a carrying mechanism can be attached. The carrying cavity 115 can be an opening in the multi-signal identification badge, such that lanyard clips or other carrying devices can be thread through the opening of the carrying cavity 115. In some embodiments, the carrying cavity 115 can instead be magnets, snaps, or other connecting methods inset into the front face or the back face of the multi-signal identification badge instead of the opening, to which carrying devices can be hooked to the multi-signal identification badge 100.

FIG. 1B depicts a perspective view of a back face 140 of a multi-signal identification badge 100 which includes interactive features that include a button 120 and LED 125 for information communication with a user. The LED 125 can be used by the system to communicate with the user of the multi-signal identification badge 100. The system using a system controller can send different flashing light patterns or colors to the LED 125 to communicate a message. In some embodiments a color may indicate a message to the user of the badge. For example, a consistent red color on the LED 125 may indicate the multi-signal identification badge 100 has been identified to be in an unauthorized location or a consistent green color on the LED 125 may indicate the if the multi-signal identification badge 100 is requested to call or check in with a supervisor or at a docking station. In some embodiments, the LED 125 may provide the user with messages from the system depending on the duration of a flash. For example, the LED 125 may show a solid color if the badge is identified as being in an unauthorized zone. The LED 125 may flash at a first pace to indicate a low battery and flash at a second pace to indicate the user needs to check in. Although depicted as part of the button 120, the LED 125 may be located at another desired location without departing from the scope of this disclosure. The multi-signal identification badge 100 has edges 130 surrounding the multi-signal identification badge 100.

In some embodiments, the back face 140 can have a computer readable code or serial number 142 associated with the electronics or internal units within the cavity of the multi-signal identification badge 100 for registering the device or badge with the systems or networks, associating the device or badge with the identity of the user, etc.

FIG. 1C depicts a side view of a multi-signal identification badge. The back face 140 includes a beveled edge 135 that extends from a back surface 145 to the identification face 105. The beveled edge 135 can extend around the whole perimeter of the multi-signal identification badge 100, or around only a part of the perimeter of the multi-signal identification badge 100. The beveled edge 135 can extend at an angle between the back surface and the edges 130.

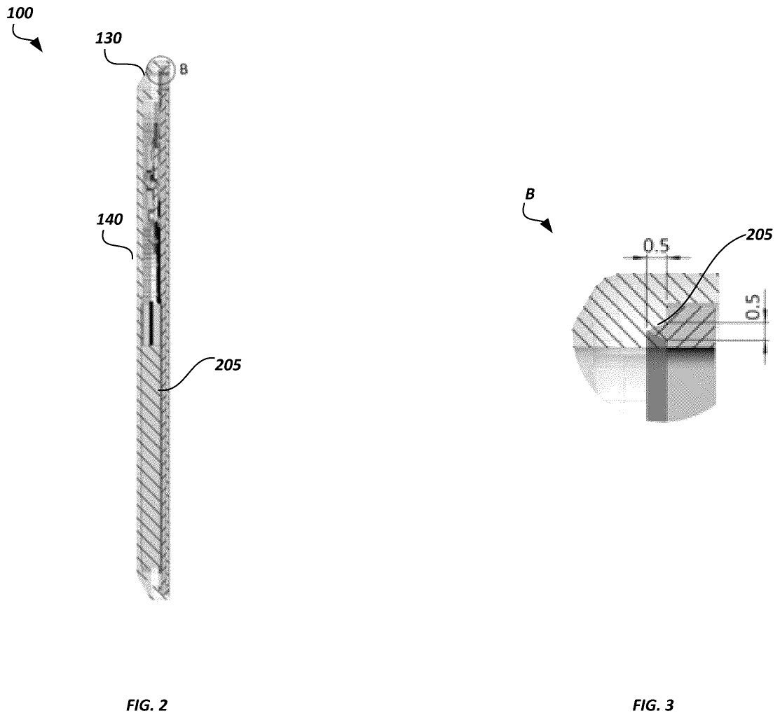

FIG. 2 depicts a cross sectional view of the multi-signal identification badge 100 where a back face 140 of the multi-signal identification badge 100 includes a beveled edge 130. FIG. 2 shows the internal components including a weld bead 205. The weld bead 205 extends along the edge of the multi-signal identification badge 100 between the identification face 105 and the back face 140.

FIG. 3 depicts a magnified view of area B of FIG. 2 of the multi-signal identification badge 100 where the back face 140 includes a beveled edge 135. The weld bead 205 connects the identification face of the badge to the back face.

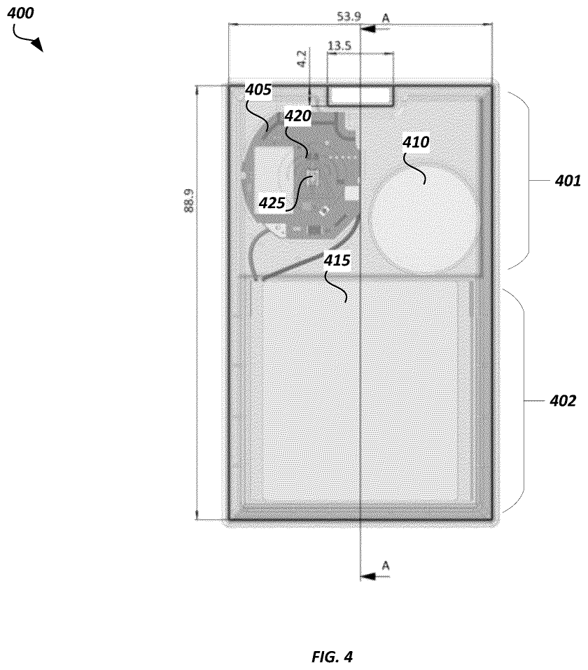

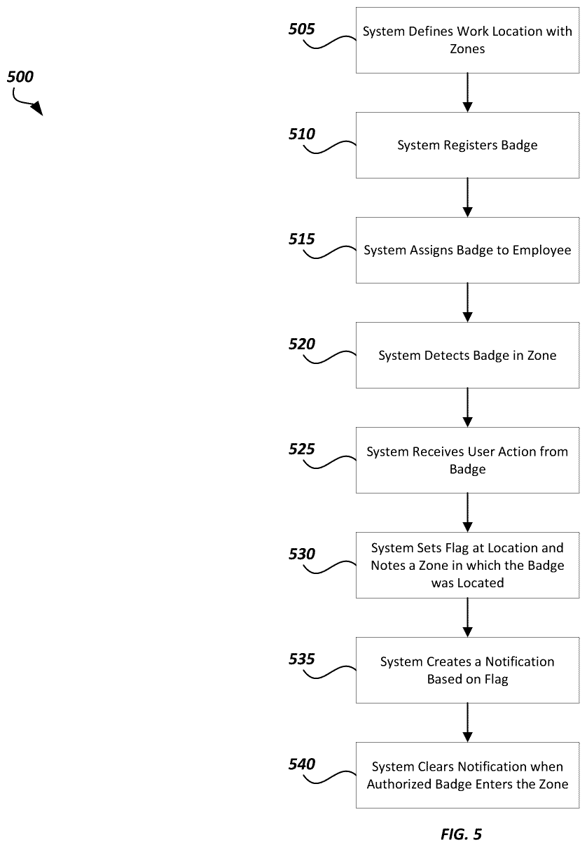

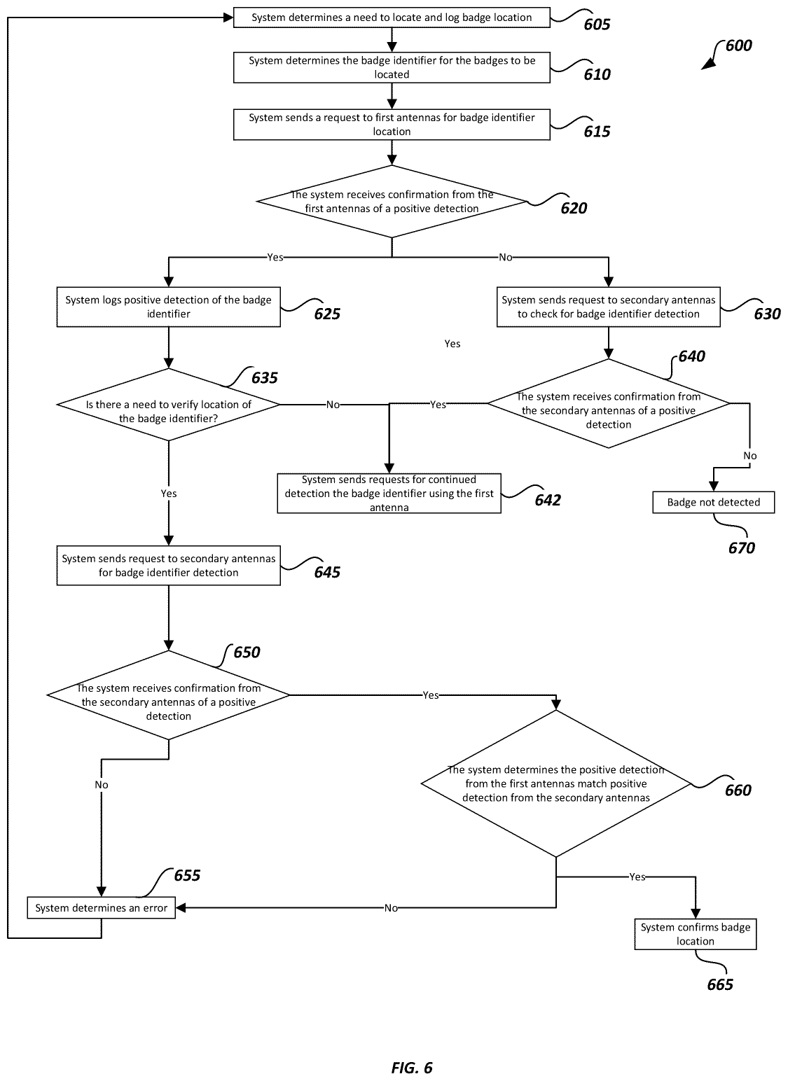

FIG. 4 depicts an internal view of a multi-signal identification badge 400 with a back face of the badge removed. The multi-signal identification badge 400 includes at least a first signal device 405, a second signal device 410, and a battery 415. The first signal device 405 can be configured to provide a first signal that can be used by the system to detect and locate the multi-signal identification badge 400. For example, the first signal device 405 can utilize global positioning systems (GPS), cellular signals, wi-fi-signals, Bluetooth®, radio-frequency identification (RFID), near field communication (NFC), long range (LoRa), ultra-wideband (UWB), and like signals to detect and locate the multi-signal identification badge 400. Using some technologies, the location of the multi-signal identification badge 400 can be triangulated using the strength of satellites, cell towers, wi-fi connection devices and the like. Using some technologies, specific signal detectors may be installed on the premises to be used with one or more multi-signal identification badges 400.

The second signal device 410 can be configured to emit a second signal for other purposes such as for digitally unlocking doors, sending and receiving instructions, scanning user information into a docking station, etc. The second signal device 410 can be any device that emits a signal that can emit identifying information to a signal detector. For example, in some embodiments, the second signal device 410 can utilize RFID, Bluetooth®, NFC, and the like.

To prevent electrical interference between the first and second signals, the first signal device 405 situated alongside the second signal device 410 rather than stacking the first signal device 405 and second 410 signal device, where each signal device can interface with a front face and a back face of the multi-signal identification badge. The first signal device 405 and second signal device 410 are disposed in an upper section 401 of the multi-signal identification badge 400 and the battery 415 is disposed in a lower section 402 of the multi-signal identification badge 400. The battery 415 is situated such that it does not come in physical contact with either the first signal device 405 or second signal device 410 to prevent signal distortion. By keeping the battery 415 in the lower section 402 and the first signal device 405 and second signal device 410 in the upper section 401, the multi-signal identification badge 400 can be destroyed and the battery 415 can be separated from the first signal device 405 and second signal device 410 by cutting along a line or a plane separating the upper section 401 from the lower section 403. The battery can, in some embodiments last up to 5 years to prevent the need from frequent reassignment of multi-signal identification badges and limit waste.

The interactive devices of the multi-signal identification badge 400 include a button 420 and LED 425 that are electrically connected to the second signal device 410. The second signal device 410 can accept input from the button 420 and can transmit the input to a command center such as a system controller that can keep and coordinate information to and from one or more multi-signal information badges 400. For example, the user can select the button 420 to alert a superior to a dangerous situation, to request assistance, or to check in as being safe or in action. The LED 425 can be used by the system to communicate a message to the user, or the system can be used to communicate a message to the user via the LED 425. In some embodiments, the LED 125 may indicate multi-signal identification badge 400 status, such as low battery, or detection in an unauthorized zone.

FIG. 5 is an illustrative flow diagram of a multi-signal identification process 500. The multi-signal identification process 500 begins in step 505, wherein a defined work area to be covered by a multi-signal identification system is configured into zones. The multi-signal identification system can include one or more multi-signal identification badges 400, sensors to detect multi-signal identification badge 400 locations, sensors to detect multi-signal identification badge 400 identification and/or permissions, and/or computing devices to accept sensor data, store sensor data, and transmit sensor data. In some embodiments, the sensors can be antennas configured to detect and emit multi-signal identification badge 400 signals.

Zones can be segments of an area, such as a facility or workspace. In some embodiments, zones can be segments of an area with like traits. For example, zones can be defined by a field of detection of a sensor or sensor. The sensors, or sensors, are configured to detect multi-signal identification badges 400, therefore if a zone is defined by a sensor or sensor field of view, each zone ends where the field of view ends and adjacent zones are under the detection of other sensors or sensors. In some embodiments, zones can be defined by what is accessible within a zone. For example, one zone may include a section of a warehouse while a different zone may include a front office.

In some examples, a zone may be defined by users of the system, such as administrators within a company utilizing the system. In some examples, the zones can be created by the system, for example using the system controller, using maps of the facility or workspace to be zoned. The zones can be altered by the system or by users of the system. A system may be initialized with zones and then may record multi-signal identification badge 400 use over time to determine if a zone should be adjusted. For example, as multi-signal identification badges 400 are detected in locations in the workspace, badges may routinely be identified going only a small amount outside of a zone and back into a zone throughout the day. The system, for example using the system controller, may determine that the location just outside of the zone has equipment or space needed for the users of the multi-signal identification badges 400 that are assigned to a zone. The system may then update, or notify a system administrator of a possible update, for the zone.

In some embodiments, an area may be configured into zones based on the types or usages of the segments of the area. For example, the area may be configured into non-detecting zones, work zones, unauthorized zones, and/or the like. In some embodiments, zones may be characterized by authority required to be in a certain area. For example, if a zone has dangerous equipment in it that only trained employees may approach, a zone may be set around the equipment that can have limited access.

In some cases, a system at a facility or workplace using multi-signal identification badge 400 location detection may exclude location detection in certain areas. These areas could include break areas such as lunchrooms, bathrooms, human resource offices, medical aid stations, etc. To prevent detecting badges in those areas, the system, may include certain defined borders as transition zones in which, if a badge is detected as passing through the transition zone, the detection for that badge ceases until it is redetected in that zone. In some examples, the non-detectability zones may have sensors or sensors, but the system may not store detection information from those sensors or sensors.

The process 500 moves to step 510, wherein the system registers a multi-signal identification badge 400. During this step, the system and the multi-signal identification badge 400 must be configured through signal channels or otherwise to communicate such that the system recognizes the multi-signal identification badge 400. The multi-signal identification badge 400 can emit unique signals from the first signal device 405 and the second signal device 410. When registering the multi-signal identification badge 400, system can collect and log within a memory the first signal from the first signal device 405 and the second signal from the second signal device 410 such that, when the first or second signal is detected in the future, the system can identify the multi-signal identification badge 400 with which the signal is associated. For example, the first and second signals may be RFID signals operating in two distinct frequencies. The frequencies can be recorded as being associated with the multi-signal identification badge 400 such that when either RFID frequency is detected by a signal detector of the system, the system can identify the multi-signal identification badge 400 that was detected. In some embodiments, communications between the system and the multi-signal identification badge 400 are customizable so that more than one system can be used in the same location without interference. For example, a first system may be configured to identify and record detection and location of certain signals, and a second system may be configured to identify and record detection of other signals. Signals could be differentiated by frequency, signal type, and the like. In some embodiments, the first system may determine a location of the multi-signal identification badge 400. A system administrator may define which signals are identified and recorded by a system.

The process 500 moves to step 515, wherein the system, for example using the system controller, assigns a multi-signal identification badge 400 to an employee. In some examples, within a stored memory the system, for example using the system controller accessing a system memory, can store the first signal and second signal associated with a multi-signal identification badge 400 with multi-signal identification badge 400 user identifying information. For example, the first signal may be a first RFID frequency and the second signal may be a second RFID frequency that are stored with an employee name, employee ID number, permitted zones, equipment permissions and the like. If the system detects at a sensor the first RFID frequency, the system, for example using a system controller, can determine which multi-signal identification badge 400 and by extension, which employee has been detected using the first RFID frequency. In some examples, the employee may have permissions to operate equipment defined within the system. For example, if a sensor of the system detects a second RFID frequency being used to initiate a piece of equipment within the facility, the system controller of the system may check to see if the employee associated with the multi-signal identification badge 400 of the second RFID frequency is permitted to run the equipment. In some examples, badges can be reassigned to a different employee by editing the employee information stored with the signal information about the multi-signal identification badges 400.

The process 500 moves to step 520, wherein the system using the system using a sensor detects a multi-signal identification badge 400 in a zone. Multi-signal identification badge 400 detection may happen continuously such that the system will check for multi-signal identification badges 400 using sensors within zones. Once a sensor detects a multi-signal identification badge 400, the system may, at the direction of the system controller, take an action such as recording the location of the multi-signal identification badge 400 at the time of detection. The system may utilize continuous multi-signal identification badge 400 detection by detecting a multi-signal identification badge 400 at a sensor and comparing the location to a previous location of the multi-signal identification badge 400.

In some embodiments, the system will determine the duration of time a multi-signal identification badge 400 is within a zone. In some embodiments, sensors can be on thresholds between zones, such that if a multi-signal identification badge 400 crosses a threshold, the system may start or stop zone timers. For example, if a multi-signal identification badge 400 is detected to be in a first zone, a first zone timer may be initiated. If the multi-signal identification badge 400 is detected by a threshold sensor to have relocated to a second zone, the system may stop the first zone timer and begin a second zone timer. In some embodiments, the timers are controlled at the direction of the system controller.

The zones of step 505 can be segmented into authorized and unauthorized zones. In some embodiments, the system may receive a list of employees and the zones they are authorized to enter. When a sensor of the system detects a multi-signal identification badge 400 in a zone, the system can compare the multi-signal identification badge 400 signal to determine the employee associated with the multi-signal identification badge 400. The system can search through the list of authorizations to determine if the employee is authorized to access the zone. If the system determines the multi-signal identification badge 400 is carried by an employee that is authorized to be in the zone, the system may take no action. If the system determines the multi-signal identification badge 400 is carried by an employee that is not authorized to be in the zone, the system may alert a supervisor of the employee, or may send an indication through the LED 425 of the multi-signal identification badge 400, to remind the user that they are not permitted to be in the zone they are currently in.

The process 500 moves to step 525, wherein the system receives a user action from the multi-signal identification badge 400. The user action may include the user interacting with an interaction feature such as pressing the button 420 on the multi-signal identification badge 400 or otherwise emitting a signal from the badge. The system can determine what kind of user action occurred and can, using the system controller set a flag at the location of the multi-signal identification badge 400 at the time of the user interaction. For example, the user action maybe a press of the button 420 which causes provides an indication to the system or a system administrator. Different interactions with the interactive features may result in different indications to the system. For example, the button 420 may be pressed for a single, short duration that sends a first indication or a single, long duration that sends a second indication. Further, the button 420 may be pressed in patterns that send distinct indicators.

The process 500 moves to step 530 in which a received user interaction with an interactive feature of the multi-signal identification badge 400 indicates an action needs to be taken. In response, the system at the system controller sets a flag at the location of the multi-signal identification badge 400 within a facility. For example, the user may press the button 420 one time to indicate a problem within the zone in which the multi-signal identification badge 400 is located that needs to be addressed by a supervisor. The system can, in response to receiving the indicator, flag the zone using the system controller.

Continuing at step 535, the system may cause notifications at the multi-signal identification badge 400 of equipment and/or employees that can resolve the flag. For example, the notification may be provided to multi-signal identification badges 400 using the LEDs 125 on the multi-signal identification badge 400 of those employees. In some embodiments, the system using, for example, the system controller may translate the notification to e-mail employees, make a voice automated announcement, etc. to notify the employees who can address the flag, cause automatic movement of an autonomous guidance vehicle, turn on or turn off processing equipment, stop a vehicle, etc.

Once the system receives input that a resource is addressing the flag, the system clears the notification and the flag at step 540. In some embodiments, once a multi-signal identification badge 400 of an employee or equipment that can address the issue is detected by sensors as being within the zone in which the flag is set, the system clears the notification and/or the flag. In some embodiments, each zone has a system hub of the system in which users can manually check in as being within the flagged zone. The system hub can be a computing device that a user can log into to access the system. In some embodiments, user interaction at the badge that first identified the issue indicate the supervisor or other employee has arrived at the site of the issue, and the notification can be cleared.

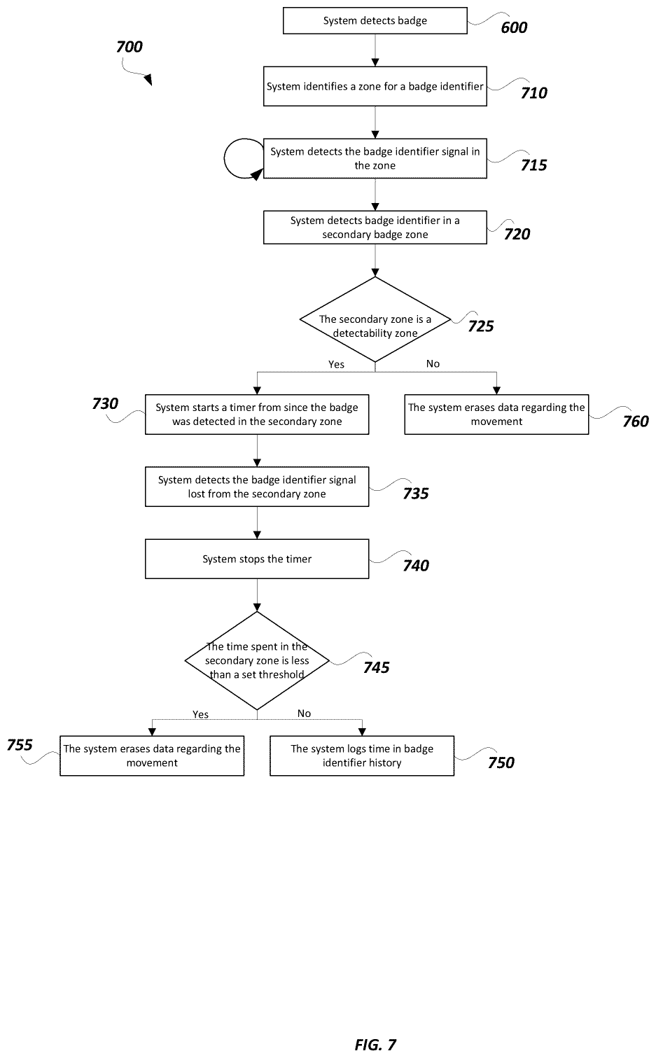

FIG. 6 is an illustrative flow diagram of a multi-signal identification badge 400 detection process 600 of a multi-signal identification system. At step 605, the system controller of the system determines a need to locate and log a multi-signal identification badge 400 location. The system controller may record the time intervals between logs and may determine the need to locate and log badge locations based on the time since the previous log. In some embodiments the system controller may determine a need to locate and log a particular multi-signal identification badge 400 associated with a particular employee such as when an employee's shift is set to start or at the direction of a system administrator.

At step 610, the system controller of the system determines the badge identifiers for the multi-signal identification badges 400 to be located. The system controller of the system uses the badge identifiers to determine the location of the multi-signal identification badges 400. A badge identifier can be, for example, an RFID frequency. In some embodiments, the system controller may identify multi-signal identification badges 400 scheduled to be within the zones at the time. The system at the system controller may also determine that one or more multi-signal identification badges need to be located. The system controller may then only attempt to locate the multi-signal identification badges 400 associated with specific badge identifiers. Other examples may include the system at the system controller searching for one or more badge identifiers based on timing, area of responsibility, or locations.

At step 615, the system using the system controller sends a request to one or more system sensors of a first set of sensors to detect a badge identifier to determine a multi-signal identification badge 400 location. System sensors may be configured to transmit and receive signals to and from the badges. Once the one or more system sensors receive the request from the system controller, the one or more system sensors search the field of view for the signal associated with the badge identifier from the system request. For example, the one or more system sensors may be sensors that receive signals from the first signal device 405 of the multi-signal identification badge 400 of FIG. 4.

If the system at the system controller, at step 620, receives confirmation from the system sensors that the one or more multi-signal identification badges 400 have been detected by their badge identifiers, the system logs a positive detection of the badge identifier at step 625. If the system controller, at step 620, does not receive confirmation from the one or more system sensors that the one or more badges have been detected by their badge identifiers, the process 600 moves to step 630, where the system controller can then send requests to a second set of sensors that can detect signals emitted from the second signal device 410. Because the second signal device 410 may be used for unlocking doors or logging into devices, the system may determine if the multi-signal identification badge 400 is detected by the other system sensors by recent use of the card at a sensor. Recent use may be set by the system depending on the area or expectation of time between multi-signal identification badge 400 uses. If, at decision state 640, the one or more second signal sensors do not return a positive detection, the process 600 moves to step 670, and badge is determined not to be found. If one or more second signal sensors return a positive detection at step 640, the process 600 moves to step 642 system may request continual monitoring of the multi-signal identification badge 400 by that sensor.

Returning to step 625, if the multi-signal identification badge 400 has been positively detected, the process 600 moves to decision state 635, wherein the system controller can determine if there is a need to verify the location of the badge identifier. For example, if the multi-signal identification badge 400 is determined to be located by a system sensor the system controller did not expect that multi-signal identification badge 400 to be detected by, the system controller can determine further verification is required. If, in decision state 635 further verification is not required, the process 600 moves to step 642, wherein the system may continue detecting the multi-signal identification badge 400 with the badge identifier using the system sensors. If in decision state 635 the system determines a need for verification, the process moves to step 645, the system controller sends a request to one or more second signal sensors for detection of the badge identifier. The process 600 moves to decision state 650, wherein the system determines whether there is a positive detection of from the secondary antennas of a positive detection. If in decision state 650 the system does not receive positive detection from the one or more second signal sensors, the process moves to step 655, wherein the system controller determines there was an error and may take additional precautions such as notifications to users or a recheck of the badge identifier and one or more first signal sensors. If, at decision state 650 the system controller receives a positive detection from the one or more second signal sensors of the badge and badge identifier, the process 600 moves to decision state 660 wherein the system controller determines whether the positive detection from the first antennas match a positive detection from the secondary antennas. If in decision state 660 the system controller determines that the positive detection from the first and second antennas match, the process moves to step 65, wherein the system controller confirms a positive location detection, and logs the location.

If, in decision state 660 the system controller does not determine a match between the first antennas and the secondary antennas, the process moves to step 655, wherein the system determines an error has occurred. The process 600 then returns to step 605, wherein the system determines a need to locate the badge.

In some embodiments, the system controller may further compare the location of a multi-signal identification badge 400 by one or more sensors from the first set of signal sensors and/or one or more sensors from the second set of signal sensors to a map of zones as determined by the system for example using the process in FIG. 5. Once the location has been determined, the system controller may determine what zone the detected multi-signal identification badge 400 is in upon detection and log the zone along with, or instead of, logging the location. In some embodiments, the system controller may use the zone map of the system and the employee information associated with the multi-signal identification badge 400 and badge identifier to complete a check to determine if the multi-signal identification badge 400, and therefore the employee, is in a zone the user is authorized to occupy. In some embodiments, the system controller may determine the zone in which the multi-signal identification badge 400 is in has been designated as a non-detectability zone. If the system controller determines the badge is in a non-detectability zone, it may delete any logs created regarding the detection or may not log any data regarding the detection.

FIG. 7 shows a process 700 for detecting multi-signal identification badges 400 to determine user movement and zone location implemented multi-signal identification system. Using the process such as the process of FIG. 6, the system detects a multi-signal identification badge 400 at 600. After a multi-signal identification badge 400 has been detected, at step 710 the system controller determines a first zone in which the multi-signal identification badge 400 was detected, the first zone being a detectability zone. In some embodiments, the system controller can compare the detected location against a map determined by the system of zones. In some embodiments, the system can determine a zone by the sensor that detected the multi-signal identification badge 400.

The process 700 moves to step 715, where the system controller continues requesting detection of the multi-signal identification badge 400 using the badge identifier. Once the multi-signal identification badge 400 is no longer detected in the first zone, the multi-signal identification badge 400 renews the request for detection. The renewed request may follow the process as in FIG. 5 and may search all of the one or more first signal sensors for detection of all badge identifiers or only request detection from surrounding one or more first signal sensors to find the single badge using the badge identifier.

At step 720, the system controller receives a positive detection from the one or more first signal sensors as in FIG. 5, at a secondary zone that is different than the first zone. Once the secondary zone has been defined as the current zone of the badge, the process 700 moves to decision state 725, wherein the system determines if the secondary zone is a detectability zone. If the system determines in decision state 725 that the secondary zone is not a detectability zone, the process 700 moves to step 760, wherein the system erases any data regarding the movement and does not store any data on the badge while it is in the secondary badge zone.

If, in decision state 725 the system determines the secondary zone is a detectability zone, the process 700 moves to step 730, wherein the system begins detecting time since the multi-signal identification badge 400 was detected in the secondary zone. The system continues to request detection of the multi-signal identification badge 400 in the secondary zone to determine if the badge stays in the secondary zone.

The process 700 moves to step 740, wherein, if the multi-signal identification badge 400 is lost from the secondary zone the system stops detecting the time the multi-signal identification badge 400 was within the secondary zone.

The process 700 moves to decision state 745, wherein the system compares the timer against a set threshold to determine if the time captured exceeds an amount. If the time the multi-signal identification badge 400 was within the secondary zone is less than a set threshold 750, the process 700 moves to step 755, wherein the system erases the data associated with the badge being in the secondary zone. If, in decision state 745, the time the multi-signal identification badge 400 was within the secondary zone exceeds a set threshold, the process 700 moves to step 750, wherein the system logs the time and detection in the logs associated with the badge identifier. If the time did not exceed the threshold, the deviation from the zone is not logged. If the system determines the multi-signal identification badge 400 is not in a detectability zone, the system erases data regarding the movement.

For example, if an employee with a multi-signal identification badge 400 is detected in a first zone that is associated with tasks the employee does for work and the employee subsequently moves to a secondary zone that is not associated with tasks the employee does for work, the system may determine if the employee deviated from their work for a substantial period of time or if they were just briefly away from the work zone. The time threshold may also help prevent misdetections by the system from being logged.

In some embodiments of the system and badge, the system may further define transition zones between zones. Similar to detecting multi-signal identification badges 400 non-detectability zones, the system may detect a multi-signal identification badges 400 in a transition zone which extends from a detectability zone to a non-detectability zone. If the multi-signal identification badges 400 is determined to have left the transition zone, but cannot be found in the bordering detectability zones, the multi-signal identification badges 400 is presumed to have transitioned to a non-detectability zone. When the multi-signal identification badges 400 returns to the transition zone from the non-detectability zone, the transition zone sensors can begin collecting data on the multi-signal identification badges 400 once again.

In some embodiments of the system and badge, the badges may be detected by global positioning system (GPS) location signals, the GPS signal being stored on the first signal device 405. The system may further be configured to detect the badge locations using GPS signals. Other embodiments may include badge detection using RFID, combinations of RFID and GPS, RF, NFC, or other such signals.

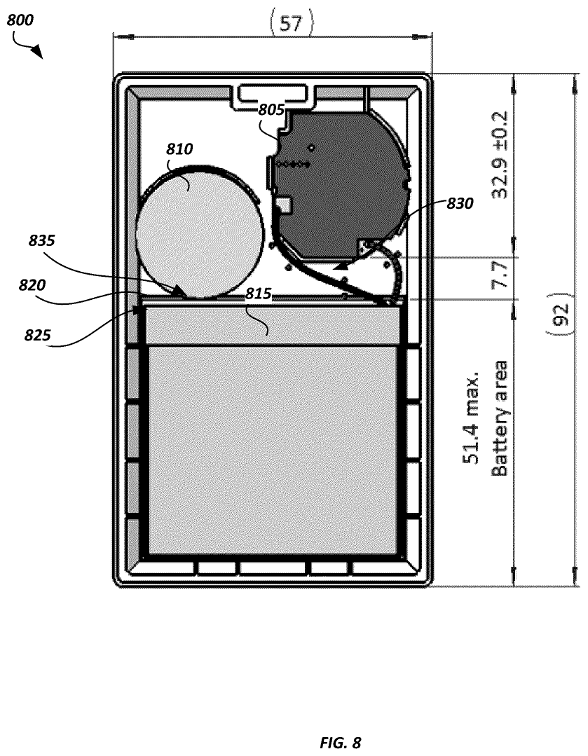

FIG. 8 depicts an internal view of a multi-signal identification badge 800 which includes a midline 820 situated between signal devices 805, 810 and a battery 815 so that, when broken, the multi-signal identification badge 800 will break along the midline 805 and the battery will not be affected, and an electrical connection between the battery and the signal devices 805, 810. A multi-signal identification badge 800 has an identification face and a back face opposite the identification face (not shown), wherein the identification face and the back face connect to form a badge cavity between the identification face and the back face. The multi-signal identification badge 800 further includes a first signal device 805, a second signal device 810, and a battery 815. A midline 820 extends through the identification face and the back face and is adjacent to an upper edge 825 of the battery 815, a lower edge 830 of the first signal device 805, and a lower edge 835 of the second signal device 810. When the multi-signal identification badge 800 is being decommissioned, the multi-signal identification badge 800 can be cut along the midline 820 to prevent the destruction of the battery 815 but to enable the signal devices 805, 810 and the multi-signal identification badge 800 to be rendered unusable. The midline 820 can be a groove embedded in the back face and/or the identification face that creates a weak point where the multi-signal identification badge 800 should break when it is cut. In some embodiments, the deactivated badge components can be removed following the cut, which does not cut any of the battery 815 or signal devices 805, 810, and can be reused in another badge. This reduces the amount of waste generated when replacing or making new badges, allowing reuse and repurposing of components.

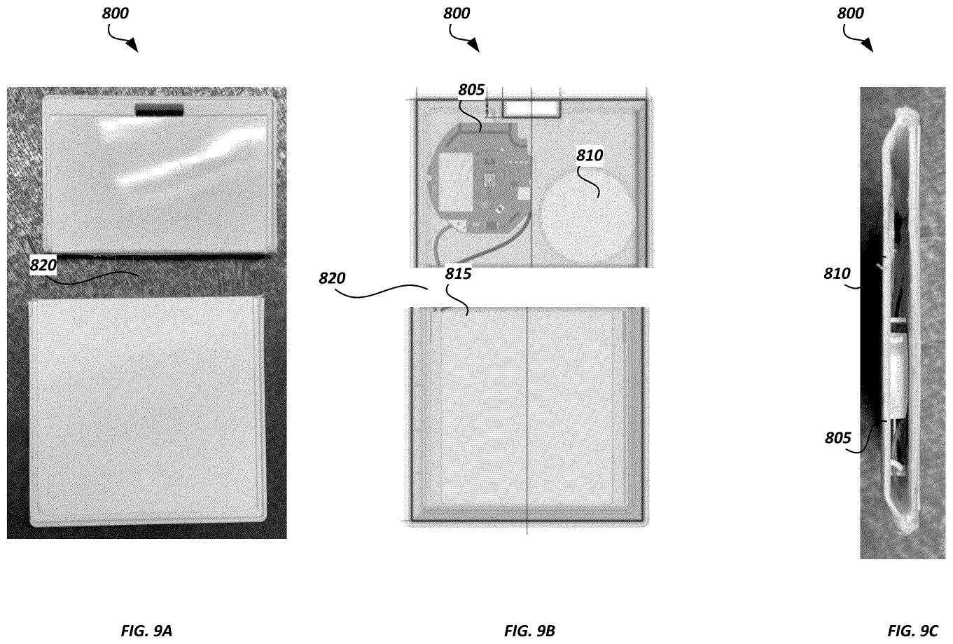

FIGS. 9A-C depicts an illustrative view of a multi-signal identification badge 800 that have been cut. The cut occurs along the midline 805 of FIG. 8. The battery 815 and signal devices 805, 810 remain intact after cutting and the electrical connection between the battery 815 and the signal devices 805, 810 are broken, and the badge 800 no longer operable or able to send or receive signals.

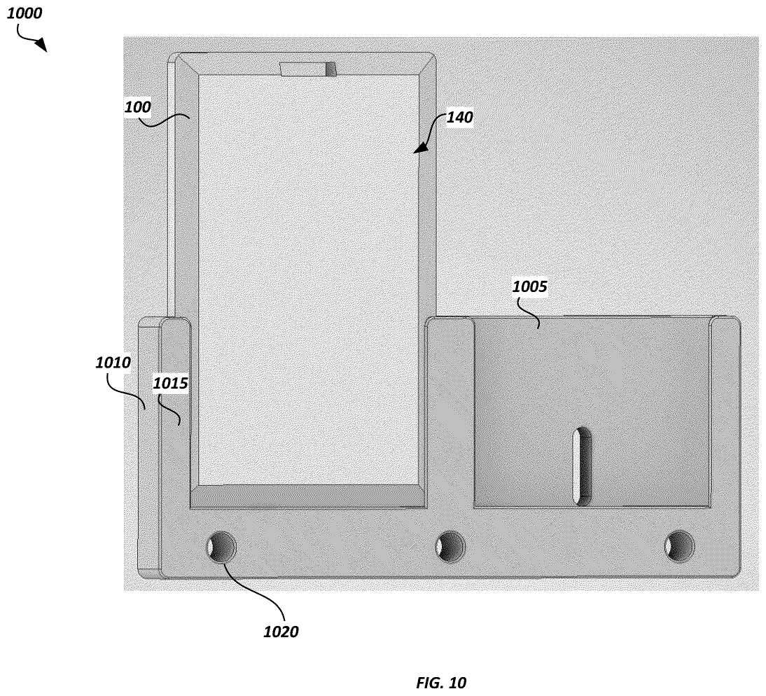

FIG. 10 depicts an illustrative multi-signal identification badge holder 1000 that can hold more than one multi-signal identification badges 100. A multi-signal identification badge holder 1000, the multi-signal identification badge holder 1000 includes a back support 1005 that extends along the identification face opposite the back face 140 of a multi-signal identification badge 100 to below a cutting line of the multi-signal identification badge 100. The multi-signal identification badge holder 1000 further includes a guiding support 1010 perpendicularly connected to the back support 1005. The guiding support 1010 is sized to securely fit adjacent to a multi-signal identification badge 100. A securing face 1015 that is opposite of the back support 1005 and perpendicular to the guiding support 1010 holds the multi-signal identification badge 100 inside a badge cavity created by the back support 1005, guiding support 1010, and the securing face 1015. The badge cavity can be sized to hold a multi-signal identification badge 100 secure while the badge is cut.

In some embodiments, to increase the stability of the multi-signal identification badge 100 within the multi-signal identification badge holder 1000 the securing face 1015 further includes a matching bevel to meet a bevel of a back face of the multi-signal identification badge. The back support 1005 is sized to extend a length corresponding to one of the two sections of the badge 100 as described above. For example, the back support 1005 may be as long as, or correspond to the length of the battery portion or the signal portion of the badge 100, such that when the badge 100 is in the holder 1000, the badge can be cut at precisely at the junction between the battery portion and the signal portion of the badge, as shown in FIGS. 9A-C. In some embodiments, the back support 1005 may be the length of the battery portion and a badge can be inserted right-side up and be cut at the right location. In some embodiments, the back support 1005 may be the length of the signal portion, and the badge can be inserted into the holder 1000 upside down so the badge 100 can be cut at the right location to deactivate the badge. In some embodiments, the badge holder 1000 positions the badge 100 to allow the badge 100 to be cut precisely along a weld bead holding the front and back surfaces together to allow the battery and the signaling devices can be removed and/or deactivated.

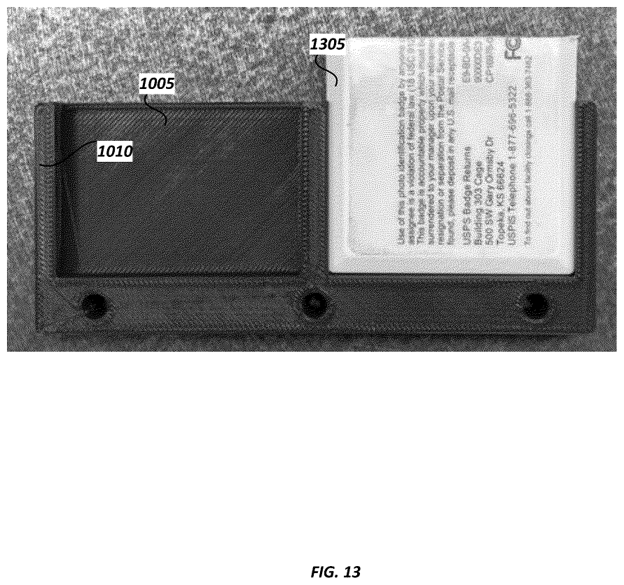

In some embodiments, the back holder 1005 may be sized to correspond to a cutting machine. The cutting machine may have a tab, a stop, or other barrier that contacts the back portion 1005. The back portion 1005 and the tab, stop, or other barrier can be sized to ensure a blade of the cutting machine cuts the badge 100 at the proper location (see FIG. 13).

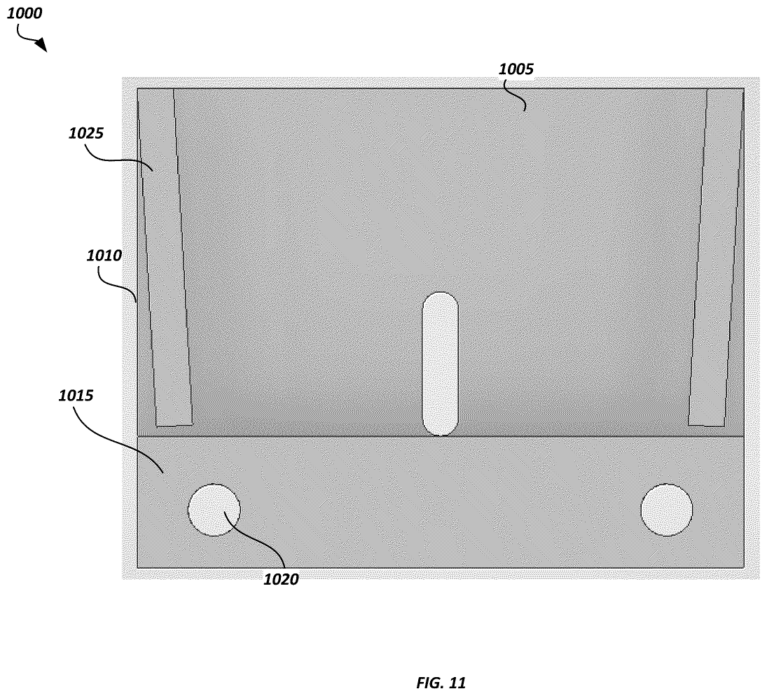

FIG. 11 depicts an illustrative multi-signal identification badge holder 1000. The multi-signal identification badge holder 1000 can include connection cavities 1020 on the securing face 1015, wherein the connection cavities 1020 can be used to hold the multi-signal identification badge holder 1000 in place. A device may be inserted into the connection cavities 1020. The device may be used to maneuver the multi-signal identification badge holder 1000 such that no human hands need to be near the multi-signal identification badge holder 1000 when cutting the multi-signal identification badge 100. Further the guiding support 1010 can include flaps 1025 that extend towards the multi-signal identification badge 100 to further secure the multi-signal identification badge 100 during a cutting process.

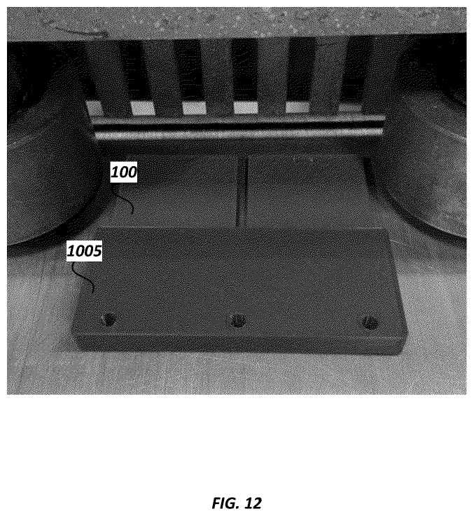

FIG. 12 depicts an illustrative multi-signal identification badge holder 1000 being used to hold a multi-signal identification badge 100 during the cutting process.

FIG. 13 depicts a multi-signal identification badge holder 1000 holding a multi-signal identification badge 100 after it has been cut where the midline is above the back support 1005 of the multi-signal identification badge holder 1000. The multi-signal identification badge holder 1000 can be chained together such that one or more multi-signal identification badge holders 1000 can be connected together along an edge of the guiding support 1010.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as specialized hardware, or as specific software instructions executable by one or more hardware devices, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A system can be or include a microprocessor, but in the alternative, the system can be or include a controller, microcontroller, or state machine, combinations of the same, or the like configured to generate and analyze indicator feedback. A system can include electrical circuitry configured to process computer-executable instructions. Although described herein primarily with respect to digital technology, a system may also include primarily analog components. For example, some or all of the features described herein may be implemented in analog circuitry or mixed analog and digital circuitry. A computing environment can include a specialized computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in specifically tailored hardware, in a specialized software module executed by a system, or in a combination of the two. A software module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. An exemplary storage medium can be coupled to the system such that the system can read information from, and write information to, the storage medium. In the alternative, the storage medium can be integral to the system. The system and the storage medium can reside in an application specific integrated circuit (ASIC). The ASIC can reside in an access device or other device. In the alternative, the system and the storage medium can reside as discrete components in an access device or other item processing device. In some embodiments, the method may be a computer-implemented method performed under the control of a computing device, such as an access device or other item processing device, executing specific computer-executable instructions.

Conditional language used herein, such as, among others, “can,” “could,” “might,” “may,” “e.g.,” and the like, unless specifically stated otherwise, or otherwise understood within the context as used, is generally intended to convey that certain embodiments include, while some embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine-readable aggregation of information such as an XML document, fixed field message, comma separated message, or the like. A message may, in some embodiments, include a signal utilized to transmit one or more representations of the information. While recited in the singular, it will be understood that a message may be composed, transmitted, stored, received, etc. in multiple parts.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present disclosure. This disclosure is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this disclosure be limited to the specific embodiments disclosed herein, but that it covers all modifications and alternatives coming within the true scope and spirit of the disclosure as embodied in the attached claims.

While the above detailed description has shown, described, and pointed out novel features of the improvements as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A system for multi-signal identification, the system comprising:
a multi-signal identification badges associated with a badge identifier, the multi-signal identification badges comprising:
a first signal device;
a second signal device; and
a battery, in electrical connection with the first signal device and the second signal device;
one or more sensors configured to detect signals emitted by the first and second signal devices;
one or more processors configured to:
determine badge identifiers for the multi-signal identification badges;
detect the multi-signal identification badge associated with the badge identifier within one of a plurality of zones of a facility;
determine a type of the one of the plurality of zones; and
log data regarding detection of the multi-signal identification badge if the multi-signal identification badge when the type of zone is a locating zone.

2. The system of claim 1, wherein the one or more processors are further configured to flag the detection of the multi-signal identification badge if the type of zone is an unauthorized zone for the multi-signal identification badge.

3. The system of claim 1, wherein the one or more processors are further configured to not log data if the type of zone is a non-detectability zone for the multi-signal identification badge associated with the badge identifier.

4. The system of claim 1, wherein in response to detecting the multi-signal badge within one of the plurality of zones, the one or more processors are further configured to:
start a timer;
detect the multi-signal identification badge associated with the badge identifier within the zone at intervals;
stop the timer once the multi-signal identification badge associated with the badge identifier is not within the one of the plurality of zones; and
determine that a time elapsed from the start of the time to the stop of the timer exceeds a time threshold.

5. The system of claim 1, wherein the first signal device operates according to a first communication protocol, and wherein the second signal device operates according to a second communication protocol different from the first protocol.

6. The system of claim 5, wherein a first set of the plurality of sensors operate according to the first communication protocol and wherein a second set of the plurality of sensors operate according to the second communication protocol.

7. The system of claim 1, wherein the one or processors are further configured to:
send a first request for detection of the multi-signal identification badge to the first set of sensors;
receive first detection analysis from the first set of sensors;
determine, based on the analysis, a need for additional detection;
send a second request for detection to the second set of sensors;
receive a second detection analysis from the second set of sensors; and
determine the zone based on the first detection analysis from the first set of sensors and the second detection analysis from the second set of sensors.

8. The system of claim 1, wherein the one or processors are further configured to:
send a first request for detection of the multi-signal identification badge to the first set of sensors;
receive first detection analysis from the first set of sensors;
determine, based on the analysis, a need for additional detection;
send a second request for detection to the second set of sensors;
receive a second detection analysis from the second set of sensors; and
determine the zone based on the first detection analysis from the first set of sensors and the second detection analysis from the second set of sensors.

9. A multi-signal identification badge, the multi-signal identification badge comprising:
an identification face;
a back face opposite the identification face, wherein the identification face and the back face connect to form a cavity between the identification face and the back face;
a first signal device, disposed in the cavity;
a second signal device, disposed in the cavity;
a battery disposed within the cavity;
a first electrical connection between the battery and the first signal device; and
a second electrical connection between the battery and the second signal device;
wherein the first and second signal device are disposed within the cavity above a midline extending through the identification face and the back face, wherein the battery is disposed within the cavity at a location below the midline, and wherein the first electrical connection and the second electrical connection cross the midline.

10. The multi-signal identification badge of claim 9, wherein the first signal device operates according to a first communication protocol, and wherein the second signal device operates according to a second communication protocol different from the first protocol.

11. The multi-signal identification badge of claim 9 further comprising a badge holder, the badge holder comprising:
a back support, the back support sized to extend along an identification face of a multi-signal identification badge to below a cutting line of the multi-signal identification badge;
a guiding support perpendicularly connected to the back support, wherein the guiding support is sized to securely fit adjacent to the multi-signal identification badge;
a securing face, wherein the securing face is opposite of the back support and perpendicular to the guiding support; and
a badge cavity, wherein the badge cavity is enclosed on four sides by the back support, securing face, and the guiding support and can hold the multi-signal identification badge.

12. The multi-signal identification badge of claim 11, wherein the securing face further comprises a matching bevel to meet a bevel of a back face of the multi-signal identification badge.

13. The multi-signal identification badge of claim 11, wherein the securing face further comprises a plurality of connection cavities, wherein the plurality of connection cavities are configured to hold the multi-signal identification badge holder in place.

14. The multi-signal identification badge claim 11, wherein the guiding support further comprise flaps that extend towards the multi-signal identification badge.

15. The multi-signal identification badge of claim 11, wherein multiple multi-signal identification badge holders can be connected together along an edge of the securing face.

16. The multi-signal identification badge of claim 11, wherein the back support is sized to be received into a badge cutting machine and position the badge within the multi-signal identification badge holder to cut the multi-signal identification badge the midline.

17. A method for detecting multi-signal identification, the method comprising:
creating zones within a defined area;
determining badge identifiers for multi-signal identification badges;
detecting a multi-signal identification badge associated with a badge identifier within a zone;
determining a type of zone; and
logging data regarding detection of the multi-signal identification badge if the multi-signal identification badge where the type of zone is a detectability zone.

18. The method of claim 17 further comprising:
receiving user action from the multi-signal identification badge;
setting a flag where the multi-signal identification badge was detected;
notifying system users of the flag, wherein a notification is sent to system users associated with the zone in which the flag was set; and
clearing the flag when a multi-signal identification device associated with the badge identifier that indicates a system user associated with the zone in which the flag was set has entered the zone.

19. The method of claim 17, wherein detecting the multi-signal identification badge associated with the badge identifier within a zone further comprises:
determining a need to locate and log badge data;
determining the badge identifier to be detected;
sending a first request for detection to a first set of sensors;
receiving a first detection analysis from the first set of sensors;
determining a need for additional detection;
sending a second request for detection to a second set of sensors;
receiving a second detection analysis from the second set of sensors; and
determining the zone based on the first detection analysis from the first set of sensors and the second detection analysis from the second set of sensors.

20. The method of claim 19, wherein the first set of sensors detects RFID signals and the second set of sensors detects NFC signals.
